(19) United States
(12) Patent Application Publication
(10) Pub. No.: US 2026/0110279 A1
(43) Pub. Date: Apr. 23, 2026

(54) AIRCRAFT COMPRISING AN IMPROVED CONTROL SYSTEM FOR THRUST REVERSERS OR FOR OPENING AND CLOSING ENGINE COWLS

(71) Applicant: AIRBUS OPERATIONS SAS, Toulouse (FR)

(72) Inventors: Eric DELMAS, Toulouse (FR); Jacques Prince MABOUNDOU NKOUKA, Toulouse (FR)

(73) Assignee: AIRBUS OPERATIONS SAS, Toulouse (FR)

(21) Appl. No.: 19/355,808

(22) Filed: Oct. 10, 2025

(30) Foreign Application Priority Data
Oct. 18, 2024 (FR) 2411336

(51) Int. Cl. F02K 1/76; B64D 27/18

(52) U.S. Cl. CPC F02K 1/763; B64D 27/18

(57) ABSTRACT

An aircraft that includes a hydraulic control system for actuators of one or more engine thrust reversers of an aircraft arranged in a propulsion system of the aircraft, the hydraulic control system has a hydraulic pressure generation assembly dedicated to the hydraulic control of the actuators and a hydraulic control controller device dedicated to the hydraulic control of the actuators. Advantageously, it is thus possible to increase the reliability and the longevity of the control system for the engine thrust reversers, to reduce the weight of the aircraft, and to simplify the hydraulic circuits for control and hydraulic generation that are made independent of the other hydraulic circuits of the aircraft.

### TECHNICAL FIELD

The present invention relates to an aircraft comprising an improved hydraulic control system for aircraft thrust reversers.

### PRIOR ART

Aircraft thrust reversers (also frequently referred to as “reverse”) are systems making it possible to temporarily orient the thrust of the engines of an aircraft forwards in order to effect braking after a landing, benefiting from the engine thrust. There are various architectures of engine thrust reversal systems, in particular with various hydraulic or electrical control systems. Although hydraulic control systems are simple and reliable, they require the use of pumps driven by the power of the engines and numerous pipes. As regards electrical control systems, which are lighter than hydraulic systems, they are more dependent on the reliability of the electrical and electronic components used and their maintenance is sometimes made complex because of the risks of obsolescence of these components.

The situation can be improved.

### SUMMARY OF THE INVENTION

An object of the present invention is to propose an aircraft comprising a hydraulic control system for reversal of the engine thrust that remedies at least some of the drawbacks of the prior art.

To this end, there is proposed an aircraft comprising two wings beneath which two aircraft propulsion systems are respectively arranged, the aircraft being arranged such that each of the propulsion systems comprises a hydraulic control system for actuators of one or more engine thrust reversers or for one or more actuators for opening and closing engine cowls of the aircraft, each of said hydraulic systems comprising:
a hydraulic pressure generation assembly dedicated to said hydraulic control of said actuators, and,
a hydraulic control and generation controller device dedicated to said hydraulic control of said actuators.

Such an aircraft architecture comprising a hydraulic control system for reversal of the engine thrust as described above makes it possible to increase the reliability and the longevity of the control system for the engine thrust reversers, to reduce the weight of the aircraft, and to simplify the hydraulic circuits for control and generation that are made independent of the other hydraulic circuits of the aircraft that the system is on board.

The aircraft comprising the hydraulic control system according to the invention may also have the following optional features, considered alone or in combination:
The hydraulic pressure generation assembly of the control system comprises at least a hydraulic control liquid reservoir, a pump for pressurizing the hydraulic control liquid, a filter for the hydraulic control liquid, a pressure accumulator reservoir for the hydraulic control liquid and a circuit for limiting the pressure in the accumulator reservoir, the pump being configured to be controlled by the dedicated hydraulic control and generation controller device.
The dedicated controller device of the hydraulic control and generation system comprises at least one interface for communication with an avionics controller of the aircraft.
The hydraulic control system further comprises at least two direction control valves for a hydraulic pressure (for a pressurized hydraulic fluid), one of which, a first valve, is configured to control an activation or deactivation of transmission of a hydraulic pressure to said actuators and the other, a second valve, is configured to control an operation of deploying and folding said one or more thrust reversers by orientation of the hydraulic pressure (of the pressurized hydraulic fluid) in the actuators, the first and second valves being configured to be controlled by the hydraulic control and generation controller device dedicated to the engine thrust reversal control system.

### BRIEF DESCRIPTION OF THE DRAWINGS

FIG. 1 schematically illustrates a hydraulic control assembly for thrust reversal of an aircraft, connected to actuators of aircraft thrust reversers, according to one embodiment;

FIG. 2 schematically illustrates details of implementation of a hydraulic pressure generation assembly of the hydraulic control assembly already depicted in FIG. 1, according to one embodiment;

FIG. 3 schematically illustrates an aircraft comprising an assembly for reversal of the engine thrust, according to one embodiment; and,

FIG. 4 is an illustration of a controller device of the hydraulic control and generation circuit already depicted in FIG. 1, according to one embodiment;

### DETAILED DESCRIPTION OF EMBODIMENTS

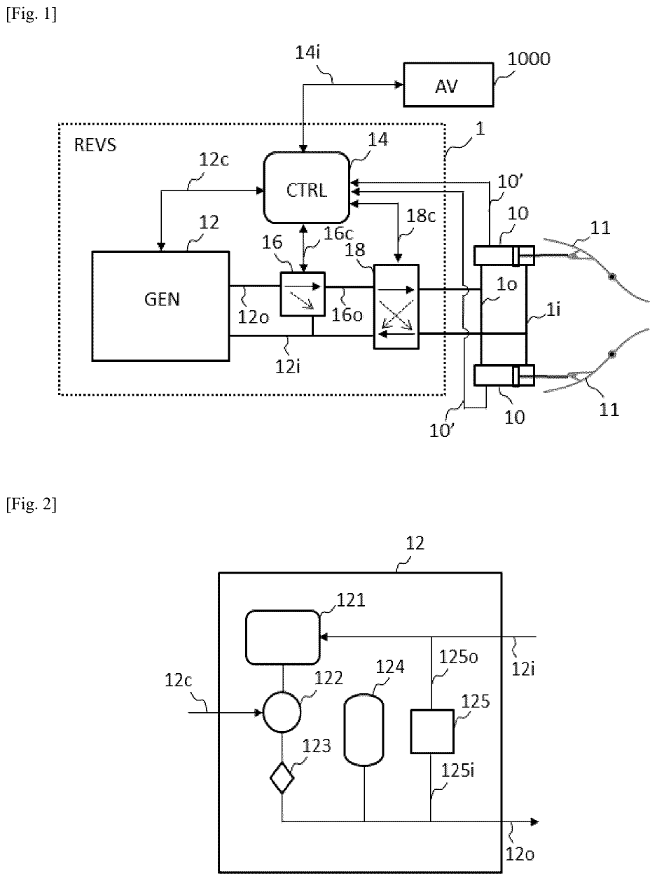

FIG. 1 schematically depicts a hydraulic control system REVS 1 designed to control two actuators 10 of reversers of the engine thrust of an aircraft engine, according to one embodiment. According to the exemplary embodiment described, the two actuators 10 are hydraulic jacks of the double-action jack type, which are each mechanically connected to an articulated thrust reverser mechanism 11. For example, the thrust reverser mechanisms 11, which are also referred to as thrust reversal mechanisms 11, are articulated or mobile and reinforced cowls that make it possible to orient a portion of an outlet flow of an aircraft engine forwards, for the purpose of effecting braking, in particular after landing of the aircraft concerned. According to one embodiment, the hydraulic control system REVS 1 is also designed to control actuators arranged for the opening and closing of one or more engine cowls of the aircraft that it is on board, for example to simplify maintenance operations when the aircraft is on the ground.

The term “forwards” here denotes the direction in which the aircraft moves in flight. According to one embodiment, the hydraulic control system 1 for reversal of an engine thrust is controlled by a controller device CTRL 14 dedicated to the function of reversal of the engine thrust, from an avionics controller AV 1000, via a bidirectional communication link or bus 14i. The controller CTRL 14 is also referred to here as the “hydraulic control and generation” controller of the hydraulic control system 1 for reversal of the engine thrust. Of course, this configuration is not limiting and the controller device 14 could be connected to two or more avionics modules, in particular for the purposes of redundancy and, consequently, of making the thrust reversal functions performed secure. The use of a plurality of avionics modules connected to the controller device 14 can also be linked to the overall architecture of the aircraft and to a distribution of the avionics functions between a plurality of avionics modules. According to one embodiment, the actuators 10 are moved in translation to deploy (or activate, or extend) the thrust reversers 11 by applying a hydraulic pressure, and therefore by moving a pressurized hydraulic fluid, via their hydraulic inlets connected to a hydraulic pipe 1o of the hydraulic control system 1. In the opposite way, the actuators 10 are moved in translation to fold (or deactivate, or stow) the thrust reversers 11 by applying a hydraulic pressure, and therefore by moving a pressurized hydraulic fluid, via their hydraulic inlets connected to a hydraulic pipe 1i of the hydraulic control system 1. Thus, when hydraulic fluid is moved in and towards the actuators 10 via the hydraulic pipe 1o, it is extracted therefrom via the hydraulic pipe 1i, and vice versa. According to one embodiment, a position signal 10′ delivered by each of the actuators 10 delivers to the controller CTRL 14 an item of information representative of the position of the actuator 10 concerned (withdrawn, extended, or an intermediate position). The movements of pressurized hydraulic fluid of the hydraulic control system 1 are effected under control of the dedicated controller device 14, which controls at least one assembly referred to as hydraulic pressure generation assembly GEN 12 and also two valves 16 and 18 for orienting the hydraulic fluid from the hydraulic pressure generation assembly 12. The controller device 14 is configured to control the hydraulic pressure generation assembly 12 via a communication bus 12c. It also controls the valve 16 via a communication bus 16c and the valve 18 via a communication bus 18c. According to one embodiment, the communication busses 12c, 16c and 18c are bidirectional communication busses adapted to the exchange of control messages and/or signals according to predetermined protocols. These protocols are not described in detail in the present description since they are not useful for understanding the invention. The valve 16, also referred to as “IV” valve (for “isolation valve”), is arranged to transmit a pressurized hydraulic fluid, available from an outlet pipe 12o of the hydraulic pressure generation assembly 12, to the valve 18, arranged to orient the hydraulic fluid alternately in the two actuators 10 (double-action jacks), so as to deploy or fold the thrust reversers 11. Thus, the valve 16 is configured to transmit hydraulic pressure between its inlet connected to the pipe 12o and one of its outlets connected to a pipe 16o to which an inlet of the valve 18, also referred to as “DCV” valve (for “directional control valve”), is connected. When the valve 16 is not configured to transmit the hydraulic pressure to its outlet connected to the pipe 16o, it transmits this pressure to the inlet pipe 12i of the hydraulic pressure generation assembly 12, which pipe then acts as a pipe for return to the hydraulic pressure generation assembly 12. As regards the valve 18, a first configuration, established under control of the controller device 14, connects the inlet pipe 16o of the valve 18 to the pipe 1o connected to the actuators 10, and also connects the pipe 1i connected to the actuators 10 to the inlet 12i of the hydraulic pressure generation assembly 12. This first configuration corresponds to a movement of the pressurized hydraulic liquid with a view to deploying the thrust reversers (translation into extension of the rod of the actuators 10). Still in relation to the valve 18, a second configuration, also established under control of the controller device 14, connects the inlet pipe 16o of the valve 18 to the pipe 1i connected to the actuators 10, and also connects the pipe 1o connected to the actuators 10 to the inlet 12i of the hydraulic pressure generation assembly 12. This second configuration corresponds to a movement of the pressurized hydraulic liquid with a view to folding the thrust reversers (translation into withdrawal of the rod of the actuators 10). The controller device CTRL 14 is considered to be a controller device dedicated to the engine thrust reversal function and to the opening and closing of engine cowls (with a view to performing maintenance operations) insofar as it does not intervene in any other function of the aircraft 100. Thus, the controller device 14 controls the deployment and folding of the thrust reversers 11 on the basis of local signals in connection with to the thrust reversal function (signals originating from pressure sensors, position sensors, load sensors, etc.) and on the basis of information obtained from the avionics module 1000 (for example the control position of the thrust reversers in the cockpit). According to one embodiment, the controller device CTRL 14 is also configured to transmit information representative of the state of the system 1 for reversal of the engine thrust by sending messages to the avionics of the aircraft after analyses of signals originating from sensors for pressure, load, deployment speed or retraction speed of one or more thrust reversers, for example.

FIG. 2 schematically illustrates details of implementation of the hydraulic pressure generation assembly 12, here referred to as assembly GEN 12. The assembly GEN 12 comprises a hydraulic liquid reservoir 121 of which the outlet is connected to the inlet of a hydraulic pump 122. The outlet of the hydraulic pump 122 is connected to the inlet of a hydraulic filter 123. The outlet of the hydraulic filter 123 is connected on the one hand to a buffer reservoir 124 of hydraulic liquid, the pressure of which is established by the controlled activation of the hydraulic pump 122, and on the other hand to the outlet pipe 12o of the assembly GEN 12. Furthermore, the inlet (or return) pipe 12i of the assembly GEN 12 is connected to an inlet of the hydraulic liquid reservoir 121, also referred to as return inlet for the hydraulic liquid. In addition, a pressure limiting module (or hydraulic circuit) 125 regulates the pressure established in the buffer reservoir 124 under the effect of the hydraulic pump 122. The pressure limiting module 125 is connected between a branch 125o of the outlet pipe 12o of the assembly GEN 12 and a branch 125i of the inlet (or return) pipe 12i of the assembly GEN 12. The module 125 is configured to release hydraulic fluid originating from the pipe 12o to the pipe 12i when a hydraulic pressure measured in the pipe 12o or in the buffer reservoir 124 exceeds a predetermined hydraulic pressure threshold. The hydraulic pump 122 is activated and deactivated under control of the controller device 14, via the bidirectional communication bus 12c. More generally, the hydraulic pump 122 is “driven” by the controller device 14, which also controls other operating parameters of the hydraulic pump 122, such as its speed or its outlet hydraulic pressure, for example.

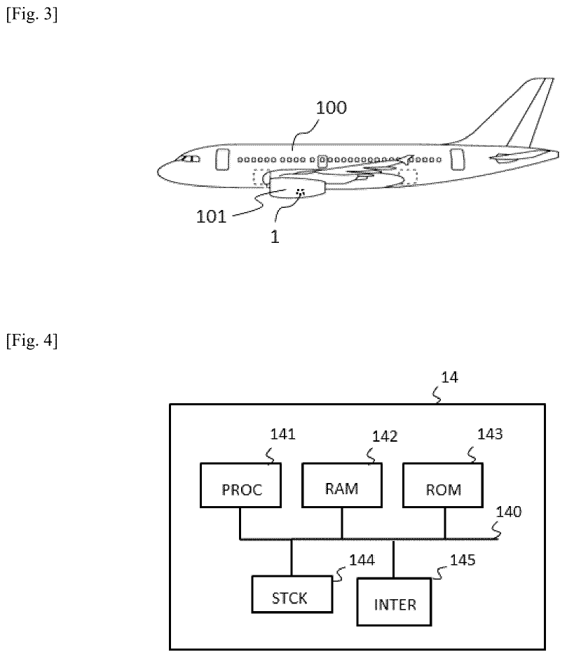

FIG. 3 schematically illustrates an exemplary implementation of the hydraulic control assembly 1 in an aircraft 100. According to the example described, the hydraulic control assembly 1 is advantageously arranged in a propulsion assembly 101, also referred to as propulsion system 101. The propulsion system 101 comprises an aircraft engine pylon, a nacelle and an aircraft engine, for example of the turboprop type. According to one embodiment, the hydraulic control assembly 1 is arranged in a nacelle of an engine of the aircraft 100 and is configured to control two reversers of the engine thrust of this engine. According to one embodiment, the aircraft 100 comprises two wings extending laterally from a central fuselage, beneath each of which a propulsion system 101 comprising a hydraulic control assembly such as the hydraulic control assembly 1 is arranged.

Such an arrangement ingeniously makes it possible to limit the elements necessary for the operation of the thrust reversal hydraulic control circuit insofar as the hydraulic pressure generation assembly is local and dedicated to the control system for the thrust reversers of the engine concerned, and possibly to the hydraulic opening and closing of one or more engine cowls of the aircraft, i.e. it is independent of any other hydraulic pressure generation system of the aircraft. Furthermore, the user of the dedicated controller device CTRL 14 operating under the supervision of at least one remote avionics module also simplifies the overall architecture of the systems that are useful for the function of thrust reversal of the engine concerned. According to one embodiment, the hydraulic control system 1, which comprises the dedicated hydraulic pressure generation assembly 12 and the dedicated controller device 14, controls, in addition to the deployment and folding of the thrust reversers 11, locking and unlocking of the thrust reversers 11 in the folded position and possibly in the deployment position. The dedicated controller device 14 is configured to control these locking and unlocking operations.

### Regarding the Deployment of the Thrust Reversers

An exemplary implementation of the hydraulic control system 1 for deploying the thrust reversers 11 is described below, according to one embodiment.

Prior to landing of the aircraft 100, a change into descent of the aircraft 100 or an extending of the landing gear of the aircraft 100 is detected by the avionics module AV 1000, which then sends the controller device 14 information representative of the context of an imminent landing of the aircraft 100. The controller device 14 then activates the hydraulic pump 122 of the hydraulic pressure generation assembly 12, and a nominal useful hydraulic pressure is then available in the hydraulic control system 1, in particular at the inlet of the valve 16. If the deployment conditions are met (for example: the thrust reversers 11 are detected in the folded (stowed) position and one or more safety locks are normally positioned and operational), then the avionics module 1000 transmits to the controller device 14 a command for deployment of the thrust reversers 11 when it detects activation of the thrust reversal system by a pilot of the aircraft 100. According to one embodiment, such a command is detected by a first predetermined position of one or more elements of the engine speed control lever situated in the cockpit. Since the required hydraulic pressure is available at the outlet of the hydraulic pressure generation assembly 12, the controller device 14 activates the valve 16 “IV” to transmit the hydraulic pressure to the valve 18 “DCV” and controls the valve 18 “DCV” to orient the hydraulic pressure in the actuators 10 according to the deployment configuration. Advantageously, the hydraulic pressure is dynamically controlled to take account of the pressure variations, head losses, wear of the hydraulic systems and possible corrosion. The pressure sensors and other elements that are useful for a hydraulic pressure servo-control are not described here in greater detail, since they are not useful for understanding the invention.

### Regarding the Folding of the Thrust Reversers

An exemplary implementation of the control system 1 for folding the thrust reversers 11 is described below, according to one embodiment.

When the avionics module 1000 detects that the aircraft 100 is on the ground with a controlled speed, that the thrust reversers 11 are normally deployed, and that a pilot has requested the folding of the thrust reversers 11 via a second predetermined position of one or more elements of the engine speed control lever situated in the cockpit, the avionics module 1000 sends the controller device 14 information representative of the context of a complete landing. Since the hydraulic pump 122 is already activated, a nominal useful hydraulic pressure is then available in the hydraulic control system 1, in particular at the inlet of the valve 16. If the folding conditions are met (for example: the thrust reversers 11 are detected in the deployment position, then the avionics module 1000 transmits to the controller device 14 a command for folding of the thrust reversers 11. The controller device 14 then controls the valve 18 to orient the pressurized hydraulic fluid into the actuators 10 according to the folded configuration. Finally, when the thrust reversers 11 are detected in the folded position, the controller device 14 controls the valve 16 to hydraulically isolate the hydraulic pressure generation assembly 12 from the actuators 10.

It should be noted that these examples of sequencing of operations of the hydraulic control system 1 are not limiting. For example, a sequence of deployment of the thrust reversers 11 and then folding of the latter can be carried out during an interruption of a takeoff phase of the aircraft 100 in the event that a prerequisite for takeoff would not be satisfied before the aircraft 100 reaches its predetermined rotational speed.

FIG. 4 schematically illustrates an exemplary internal architecture of the hydraulic control and generation controller device CTRL 14, of the hydraulic control system 1 and dedicated to this system.

According to the exemplary hardware architecture depicted in FIG. 4, the hydraulic control controller device 14 then comprises, connected by a communication bus 140: a processor or CPU (Central Processing Unit) 141; a random access memory (RAM) 142; a read-only memory (ROM) 143; a storage unit such as a hard disk (or a storage medium reader such as an SD (Secure Digital) card reader) 144; a power and communication interface module 145 allowing the hydraulic control controller device CTRL 14 to communicate with remote devices, such as avionics devices, sensors or actuators of hydraulic circuits (pump, pressure sensors, pressure limiters, valves, etc.) and to distribute the electrical power that is necessary to the various elements present in the thrust reversal system 1.

The processor 141 of the hydraulic control circuit controller device 14 is capable of executing instructions loaded into the RAM 142 from the ROM 143, from an external memory (not shown), from a storage medium (such as an SD card), or from a communication network. When the hydraulic control controller device 14 is powered up, the processor 141 is capable of reading instructions from the RAM 142 and executing them. These instructions form a computer program that causes the implementation, by the processor 141 of the hydraulic control controller device 14, of all or part of a method for controlling the engine thrust reversers of the hydraulic control system 1, in particular from information obtained from one or more remote avionics modules or controllers.

All or part of such a method for hydraulic control of the engine thrust reversers 11 may then be implemented in software form through the execution of a set of instructions by a programmable machine, for example a DSP (digital signal processor) or a microcontroller, or be implemented in hardware form by a machine or a dedicated component, for example an FPGA (field-programmable gate array) or ASIC (application-specific integrated circuit). In general, the hydraulic control circuit controller device 14 comprises electronic circuitry configured to implement a method for controlling the aircraft engine thrust reversers controlled by the hydraulic control system 1 described. Of course, the controller device 14 further comprises all the elements that are usually present in an electronic system comprising a control unit and its peripherals, such as a power supply circuit, a power supply monitoring circuit, one or more clock circuits, a reset circuit, input/output ports, interrupt inputs, and bus drivers, this list being non-exhaustive.

1. An aircraft comprising two wings beneath which two aircraft propulsion systems are respectively arranged, said aircraft of said propulsion systems comprises a hydraulic control system for actuators of one or more engine thrust reversers or for one or more actuators for opening and closing engine cowls of the aircraft, each of the hydraulic control systems comprising:
a hydraulic pressure generation assembly dedicated to said hydraulic control of said actuators, said hydraulic pressure generation assembly comprising at least a hydraulic control liquid reservoir, a hydraulic pump for pressurizing said hydraulic control liquid, a filter for said hydraulic control liquid, a pressure accumulator reservoir for said hydraulic control liquid and a module for limiting the pressure in said accumulator reservoir and,
a hydraulic control controller device dedicated to said hydraulic control of said actuators, the hydraulic pressurization pump being configured to be controlled by said dedicated hydraulic control controller device.

2. The aircraft according to claim 1, wherein said dedicated controller device comprises at least one interface for communication with an avionics controller of the aircraft.

3. The aircraft according to claim 1, further comprising at least two direction control valves for a hydraulic pressure, one of which, a first valve, is configured to control an activation or deactivation of transmission of a hydraulic pressure to said actuators, and the other, a second valve is configured to control an operation of deploying and folding said one or more thrust reversers by orientation of said hydraulic pressure in said actuators said first and second valves being configured to be controlled by said dedicated hydraulic control controller device
